(19) United States
(12) Patent Application Publication
(10) Pub. No.: US 2010/0319853 A1
(43) Pub. Date: Dec. 23, 2010

(54) Gas supply device and apparatus for processing a substrate

(76) Inventors: Woo-Seok Kim, Suwon-si (KR); Jae-Hyun Han, Hwaseong-si (KR); Joo-Pyo Hong, Seoul (KR); No-Hyun Huh, Yongin-si (KR)

Correspondence Address: HARNESS, DICKEY & PIERCE, P.L.C., P.O. BOX 8910, RESTON, VA, 20195, US

(21) Appl. No.: 12/805,819

(22) Filed: Aug. 20, 2010

Related U.S. Application Data
(62) Division of application No. 11/581,111, filed on Oct. 16, 2006.

(30) Foreign Application Priority Data
Oct. 18, 2005 (KR) 10-2005-097979

(51) Int. Cl. C23F 1/08; B05B 7/04

(52) U.S. Cl. 156/345.33; 239/398

(57) ABSTRACT

A gas supply device may include a first gas supply member that may be disposed in a chamber and around a substrate loaded in the chamber. The first gas supply member may include nozzles for providing a gas onto the substrate. A second gas supply member that may provide the gas supplied from at least one gas supply line to the first gas supply member.

### PRIORITY STATEMENT

This application is a Divisional of U.S. application Ser. No. 11/581,111 filed Oct. 16, 2006, which claims benefit of priority under 35 U.S.C. §119 from Korean Patent Application No. 10-2005-0097979 filed Oct. 18, 2005 in the Korean Intellectual Property Office (KIPO), the contents of each of which are incorporated herein by reference in their entirety.

### BACKGROUND

1. Field

Example embodiments relate to a gas supply device and an apparatus for processing a substrate having the gas supply device, for example, a gas supply device for supplying a reaction gas onto a substrate.

2. Description of the Related Art

A semiconductor manufacturing process may include a fabrication process, an electrical die sorting (EDS) process and/or a packaging process. Integrated circuits including various elements may be formed on a silicon wafer in the fabrication process. Electrical characteristics of the integrated circuits may be inspected in the EDS process. The integrated circuits may be sealed and separated individually in the packaging process.

The fabrication process may include a deposition process, a planarization process, a photolithography process, an etching process, an ion implantation process, a cleaning process, and/or an inspecting process. A layer may be formed on a semiconductor substrate during the deposition process. The layer may be patterned to form a desired pattern on the substrate through the photolithography process and/or the etching process. In the ion implantation process, impurities may be doped into predetermined or desired portions of the substrate to form impurity regions. The cleaning process may remove products and particles from the desired pattern and the substrate. The desired pattern and the substrate may be evaluated in the inspecting process.

A processing gas may be provided onto the substrate in the deposition process, for example, a chemical vapor deposition (CVD) process. An etching gas may be introduced onto the substrate in the etching process, for example, a dry etching process. The processing gas and/or the etching gas may be uniformly provided onto the substrate to ensure a deposition uniformity and/or an etch uniformity of the layer. The processing gas and/or etching gas may be introduced onto the substrate using a shower-head-type gas supply device and/or an injector-type gas supply device.

Japanese Laid-Open Patent Publication No. 2000-263141 discloses a substrate processing apparatus that may include an injector-type gas supply device. The injector-type gas supply device may provide a processing gas from a peripheral portion of a substrate to a central portion of the substrate.

FIG. 1 is a cross-sectional view of a conventional gas supply device.

Referring to FIG. 1, a conventional injector-type gas supply device 20 may include a gas member 22 and a plurality of nozzles 24. The gas member 22 may be provided along a sidewall of the chamber 10 where a substrate (not shown) may be processed. The gas member 22 may be coupled to a gas supply line (not shown) for introducing a processing gas into the chamber 10. The nozzles 24 may be connected to the gas member 22 so that the processing gas may be sprayed through the nozzles 24 onto a substrate that may be loaded in the chamber 10.

The gas supply device 20 may include one gas supply line connected to the gas member 22. The processing gas that may pass through the gas supply line and the gas member 22 may be sprayed through the nozzles 24 onto the substrate in the chamber 10.

However, the processing gas may not be uniformly sprayed from the nozzles 24 onto the substrate. For example, the gas supply line may be coupled to only one side of the gas member 22. The amount of the processing gas that may be sprayed from one nozzle 24 adjacent to the gas supply line may be different from the amount of the processing gas sprayed from the other nozzles 24 that may be located a distance away from the gas supply line. If the amount of the processing gas sprayed from the nozzles 24 are different from one another, a uniformity of a layer that may be formed on the substrate may be deteriorated. Additionally, if an etching gas is provided from the nozzles 24, a pattern that may be formed on the substrate by etching the layer may have a poor uniformity. For example, this problem may become more serious if a semiconductor device has a minute design rule and/or if a semiconductor substrate has an increased size.

### SUMMARY

Example embodiments may provide a gas supply device for more uniformly providing a gas onto a substrate.

Example embodiments may provide a substrate processing apparatus that may include a gas supply device capable of more uniformly providing a gas onto a substrate.

In an example, non-limiting embodiment, a first gas supply member may be disposed in a chamber and around a substrate loaded in the chamber. The first gas supply member may include nozzles for providing a gas onto the substrate. A second gas supply member may be connected to the first gas supply member. The second gas supply member may provide the gas supplied from at least one gas supply line to the first gas supply member.

According to an example, non-limiting embodiment, the second gas supply member may be disposed within the first gas supply member, and the second gas supply member may have a plurality of openings to connect an inner cavity of the second gas supply member to an inner cavity of the first gas supply member. The plurality of openings and the at least one gas supply line may be alternately disposed, and the plurality of openings and the plurality of nozzles may be alternately disposed. The number of the openings may be greater than the number of the gas supply lines.

According to an example, non-limiting embodiment, the first gas supply member may be disposed within and may make contact with the second gas supply member. The second gas supply member may have a plurality of openings between the first gas supply member and the second gas supply member to connect an inner cavity of the first gas supply member to an inner cavity of the second gas supply member. The plurality of openings and the at least one gas supply line may be alternately disposed, and the plurality of openings and the plurality of nozzles may be alternately disposed. The number of the openings may be greater than the number of the gas supply lines.

According to an example, non-limiting embodiment, the first gas supply member may be disposed on the second gas supply member. A plurality of openings may be formed in the contact portion where the first gas supply member and the second gas supply member make contact, and may connect an inner cavity of the second gas supply member to an inner cavity of the first gas supply member. The plurality of openings and the at least one gas supply line may be alternately disposed, and the plurality of openings and the plurality of nozzles may be alternately disposed. The number of the openings may be greater than the number of the gas supply lines.

According to an example, non-limiting embodiment, the first gas supply member may be spaced apart from the second gas supply member. The gas supply device may include a plurality of connection lines for connecting an inner cavity of the first gas supply member to an inner cavity of the second gas supply member. The plurality of connection lines and the at least one gas supply line may be alternately disposed, and the connection lines and the plurality of nozzles may be alternately disposed. The number of the connection lines may be greater than the number of the gas supply lines.

According to an example, non-limiting embodiment, the first gas supply member and the second gas supply member may each be connected to a different gas reservoir.

According to an example, non-limiting embodiment, the gas supply device may further include a sealing member for sealing connections between the at least one gas supply line and the second gas supply member.

According to an example, non-limiting embodiment, the gas supply device may further include a frame disposed in the first gas member to support the second gas supply member, which may be separated from the first gas supply member by a predetermined distance.

According to an example, non-limiting embodiment, a substrate processing apparatus may include a chamber for receiving a substrate, a stage disposed in the chamber to support the substrate, at least one gas supply unit, and a gas exhausting unit connected to the chamber to exhaust an unreacted gas and reaction by-products from the chamber.

According to an example, non-limiting embodiment, the second gas supply member may be disposed within the first gas supply member, and the second gas supply member may have a plurality of openings to connect an inner cavity of the second gas supply member and an inner cavity of the second gas supply member.

According to an example, non-limiting embodiment, the substrate processing apparatus may further include a sealing member for sealing a connection between the at least one gas supply line and the second gas supply member, and a frame disposed in the first gas supply member to support the second gas member which may be separated from the first gas supply member by a predetermined distance.

According to an example, non-limiting embodiment, the plurality of openings and the at least one gas supply line may be alternately disposed, and the plurality of openings and the plurality nozzles may be alternately disposed. The number of the openings may be greater than the number of the gas supply lines.

According to an example, non-limiting embodiment, the substrate processing apparatus may include a plurality of gas supply units stacked around the substrate. The gas supply units may each provide different gases onto the substrate.

### BRIEF DESCRIPTION OF THE DRAWINGS

Example, non-limiting embodiments will be described with reference to the accompanying drawings.

FIG. 1 is a cross-sectional view of a conventional gas supply device.

FIG. 2 is a cross-sectional view of a gas supply device in accordance with an example, non-limiting embodiment.

FIG. 3 is an example cross-sectional view of the gas supply device of FIG. 2, taken along a line III-III′.

FIG. 4 is an example perspective view of a second gas supply member of the gas supply device of FIG. 2.

FIG. 5 is a cross-sectional view of a gas supply device in accordance with an example, non-limiting embodiment.

FIG. 6 is an example cross-sectional view of the gas supply device of FIG. 5, taken along a line VI-VI′.

FIG. 7 is a cross-sectional view of a gas supply device in accordance with an example, non-limiting embodiment.

FIG. 8 is an example cross-sectional view of the gas supply device of FIG. 7, taken along a line VIII-VIII′.

FIG. 9 is a cross-sectional view of a gas supply device in accordance with an example, non-limiting embodiment.

FIG. 10 is an example cross-sectional view of the gas supply device of FIG. 9, taken along a line X-X′.

FIG. 11 is a cross-sectional view of a substrate processing apparatus in accordance with an example, non-limiting embodiment.

FIG. 12 is an example cross-sectional view of the substrate processing apparatus of FIG. 11, taken along a line XII-XII′.

FIG. 13 is a plan view of a substrate processed using a conventional gas supply device.

FIG. 14 is a plan view of a substrate processed using a gas supply device in accordance with an example, non-limiting embodiment.

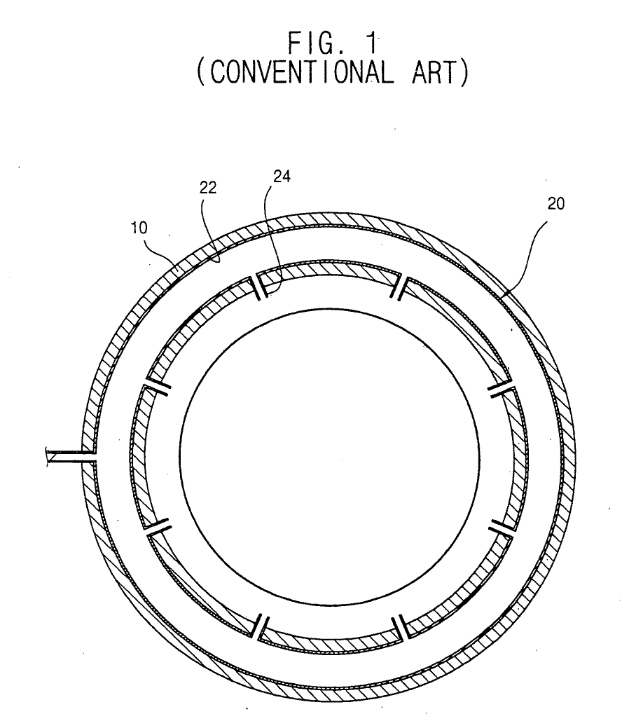

### DESCRIPTION OF EXAMPLE NON-LIMITING EMBODIMENTS

Various example, non-limiting embodiments will now be described more fully with reference to the accompanying drawings. Example embodiments may, however, be in many different forms and should not be construed as limited to the example embodiments set forth herein. Accordingly, these example, non-limiting embodiments are provided so that this disclosure will be thorough and complete, and will fully convey the scope to those skilled in the art. In the drawings, the sizes and relative sizes of the features and elements may be exaggerated for clarity.

It will be understood that when a feature or an element is referred to as being “on,” “connected to” or “coupled to” another feature or element, it can be directly on, connected or coupled to the other feature or element or intervening features or elements that may be present. In contrast, when an element is referred to as being “directly on,” “directly connected to” or “directly coupled to” another feature or element, there are no intervening features or elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer and/or section discussed below could be termed a second element, component, region, layer or section without departing from the teachings of the example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, when the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

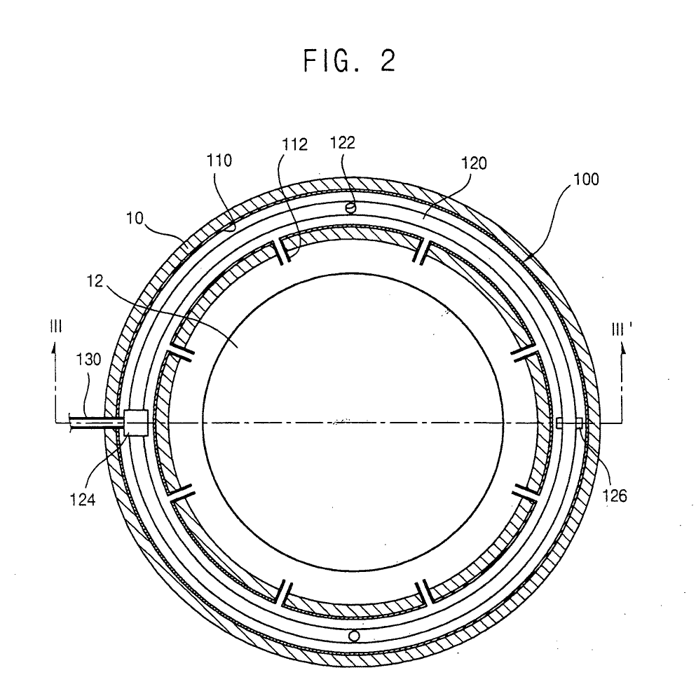

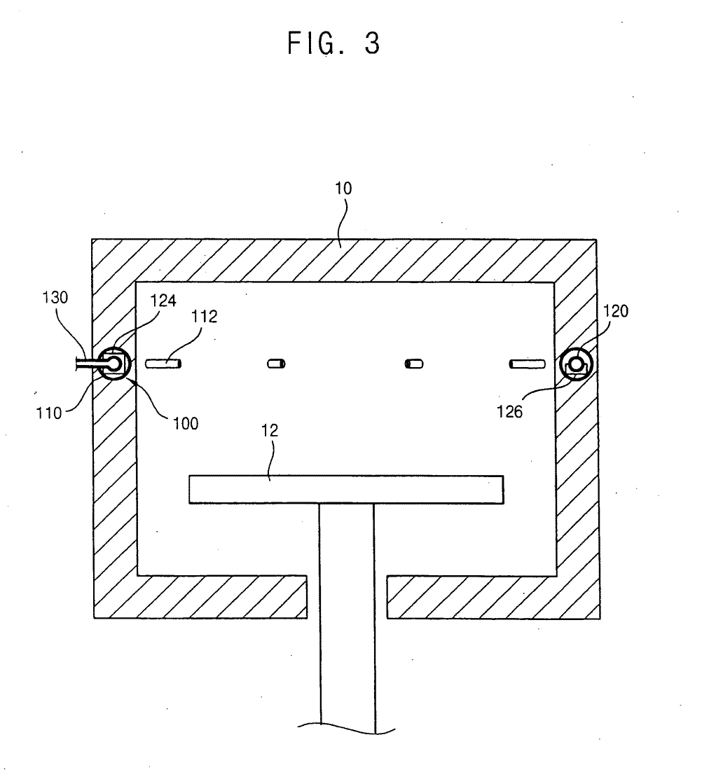

FIG. 2 is a cross-sectional view of a gas supply device in accordance with an example, non-limiting embodiment. FIG. 3 is an example cross-sectional view of the gas supply device of FIG. 2, taken along a line III-III′.

Referring to FIGS. 2 and 3, a gas supply device 100 may include a first gas supply member 110 and a second gas supply member 120.

In an example, non-limiting embodiment, the first gas supply member 110 may have a circular or substantially circular shape, for example, a ring. By way of example only, the first gas supply member 110 may have an alternative shape, for example, square, rectangular, elliptical, arcuate, polygonal, etc.

In an example, non-limiting embodiment, the first gas supply member 110 may have a cross-sectional shape that is circular or substantially circular, but is not limited thereto. By way of example only, the first gas supply member 110 may have a cross-sectional shape that is circular with a flattened edge, rectangular with rounded corners, elliptical, arcuate, polygonal, etc.

The first gas supply member 110 may be disposed in a chamber 10 that may provide a processing space where at least one substrate may be processed. The first gas supply member 110 may surround the processing space of the chamber 10. For example, the first gas supply member 110 may be integrally formed with the chamber 10, formed on a wall of the chamber 10, and/or embedded in a wall of the chamber 10. The first gas supply member 110 may be horizontally disposed with respect to the substrate loaded in the chamber 10.

The gas supply device 100 may include a stage 12 disposed in the chamber 10 to horizontally support the substrate. A position of the first gas supply member 110 may be higher than the position of the substrate supported by the stage 12.

The gas supply device 100 may include a plurality of nozzles 112 that may be connected to the first gas supply member 110. Each of the nozzles 112 may extend toward the substrate supported by the stage 12 in the chamber 10. The nozzles 112 may be uniformly spaced apart from one another.

In an example, non-limiting embodiment, the first gas supply member 110 may be enclosed a sidewall of the chamber 10. For example, the first gas supply member 110 may be spaced apart from the sidewall of the chamber 10 by a predetermined or desired distance. The nozzles 112 that may be connected to the first gas supply member 110 may pass through the wall of the chamber 10 and may extend toward the substrate loaded in the chamber 10.

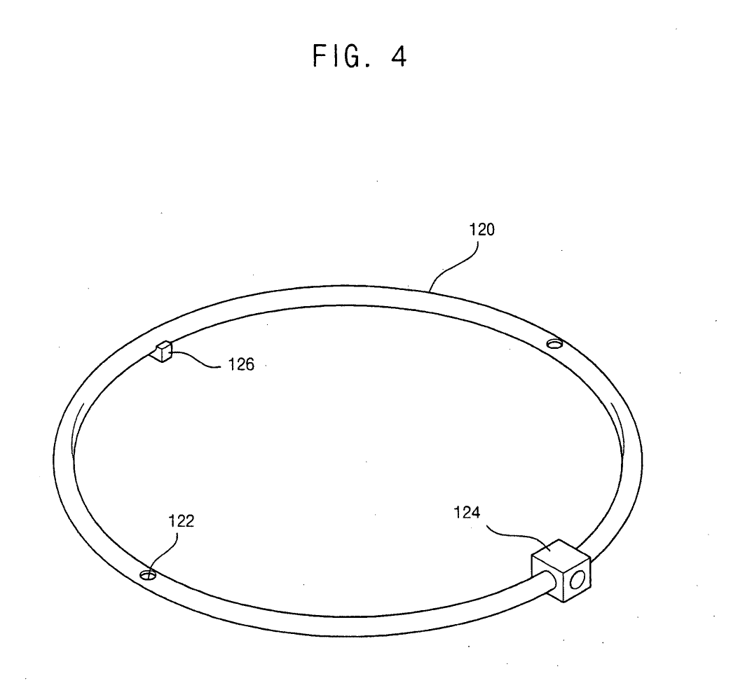

FIG. 4 is a perspective view of the second gas supply member 120 of FIG. 2.

Referring to FIGS. 2 to 4, the second gas supply member 120 may be disposed within the first gas supply member 110. The second gas supply member 120 may have a diameter smaller than a diameter of the first gas supply member 110.

In an example, non-limiting embodiment, the second gas supply member 120 may have a circular or substantially circular shape, for example, a ring. By way of example only, the first gas supply member 110 may have an alternative shape, for example, square, rectangular, elliptical, arcuate, polygonal, etc.

In an example, non-limiting embodiment, the first gas supply member 110 may have a cross-sectional shape that is circular or substantially circular, but is not limited thereto. By way of example only, the first gas supply member 110 may have a cross-sectional shape that is circular with a flattened edge, rectangular with rounded corners, elliptical, arcuate, polygonal, etc.

The second gas supply member 120 may have a plurality of openings 122 that may connect an inner cavity of the first gas supply member 110 to an inner cavity of the second gas supply member 120. For example, the openings 122 may allow the second gas supply member 120 to provide the gas to the first gas supply member 110. The openings 122 may be uniformly spaced apart from one another.

In an example, non-limiting embodiment, the openings 122 in the second gas supply member 120 may be disposed radially in the same direction, along a wall of the second gas supply member 120. For example, the openings 122 may be disposed at an upper facing portion, a lower facing portion, an inside facing portion or an outside facing portion of the second gas supply member 120, at intervals along the length of the second gas supply member 120. Alternatively, the openings 122 of the second gas supply member 120 may be disposed radially in different directions, along the wall second gas supply member 120, respectively.

In an example, non-limiting embodiment, the openings 122 and the nozzles 112 may be alternately disposed so that a gas that may be supplied from the second gas supply member 120 to the first gas supply member 110 may not be directly provided to the nozzles 112.

The gas supply device 100 may include a gas reservoir (not shown) and a gas supply line 130. The gas supply line 130 may pass through the first gas supply member 110 and may connect the gas reservoir to the second gas supply member 120. The gas reservoir may provide the gas to the second gas supply member 120. For example, the gas may include a processing gas or a reaction gas.

The gas supply device 100 may include a sealing member 124 for sealing the gas supply line 130 and the second gas supply member 120. For example, the sealing member 124 may prevent the leakage of the gas from the gas supply line 130 and the second gas supply member 120. The sealing member 124 may be disposed where the gas supply line 130 and the second gas supply member 120 may connect.

The gas supply apparatus 100 may include a frame 126 that may be disposed in the first gas supply member 110. The frame 126 may support the second gas supply member 120 disposed within the first gas supply member 110 and separate the second gas supply member 120 from the first gas supply member 110 at a predetermined or given distance. The frame 126 may horizontally support the second gas supply member 120 in the first gas supply member 110 and may ensure horizontal positions of the second gas supply member 120 and first gas supply member 110 relative to the substrate.

The openings 122 of the second gas supply member 120 may be alternately disposed with respect to where the gas supply line 130 and the second gas supply member 120 may connect. For example, the gas supply line 130 may be connected to a portion of the second gas supply member 120. The openings 122 may be positioned on the second gas supply member 120 away from where the gas supply line 120 connects with the second gas supply member 120. In this way, the gas in the second gas supply member 120 supplied through the gas supply line 130 may not be directly provided to the first gas supply member 110 through the openings 122. Instead, the gas may be more uniformly distributed in the second supply member 120 when provided to the first gas supply member 110 through the openings 122.

In an example, non-limiting embodiment, the gas supply device 100 may include one gas supply line 130 and two openings 122. The two openings 122 may be disposed across from each other centering the second gas supply member 120 by an angle of about 180°. The gas supply line 130 may be connected to the second gas supply member 120 by an angle of about 90° with respect to each of the openings 122.

In an example, non-limiting embodiment, the gas supply device 100 may include a plurality of gas supply lines 130 connected to the second gas supply member 120. The gas supply lines 130 may be connected to one gas reservoir or a plurality of gas reservoirs, respectively. The number of openings 122 may be greater than the number of gas supply lines 130. For example, if the gas supply device 100 has a plurality of gas supply lines 130, the number of the openings 122 may be greater than that of the gas supply lines 130 so that the gas supplied through the gas supply lines 130 may be more uniformly provided to the first gas supply member 110 through the openings 122. If the number of the openings 122 is the same as that of the gas supply lines 130, the amount and the uniformity of the gas supplied through the gas supply lines 130 and the openings 122 may not be improved. Accordingly, the number of the openings 122 may be larger than that of the gas supply lines 130.

The gas supply device 100 may provide the gas onto the substrate in the chamber 10 through the nozzles 112. If the gas is more uniformly distributed by the second gas supply member 120 and the first gas supply member 110, and the gas may be more uniformly provided onto the substrate loaded in the chamber 10 so that the substrate may be uniformly processed by the gas.

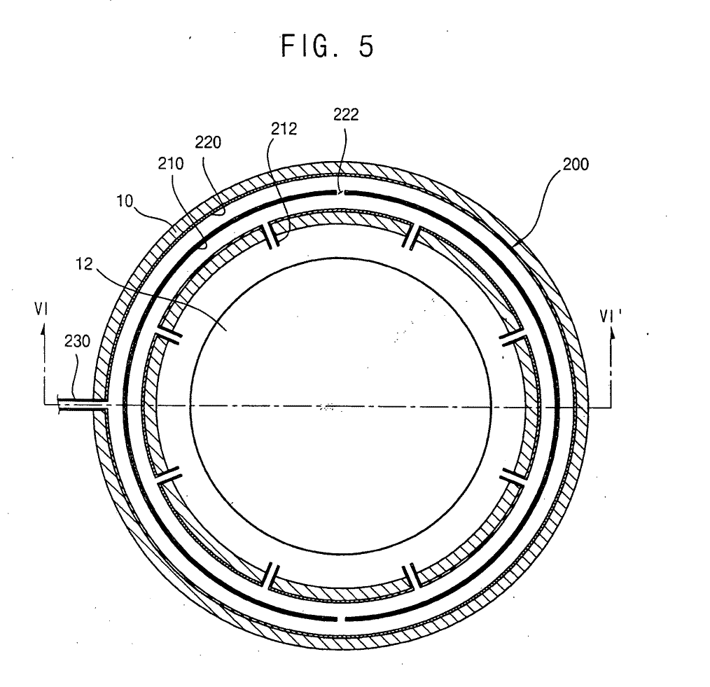

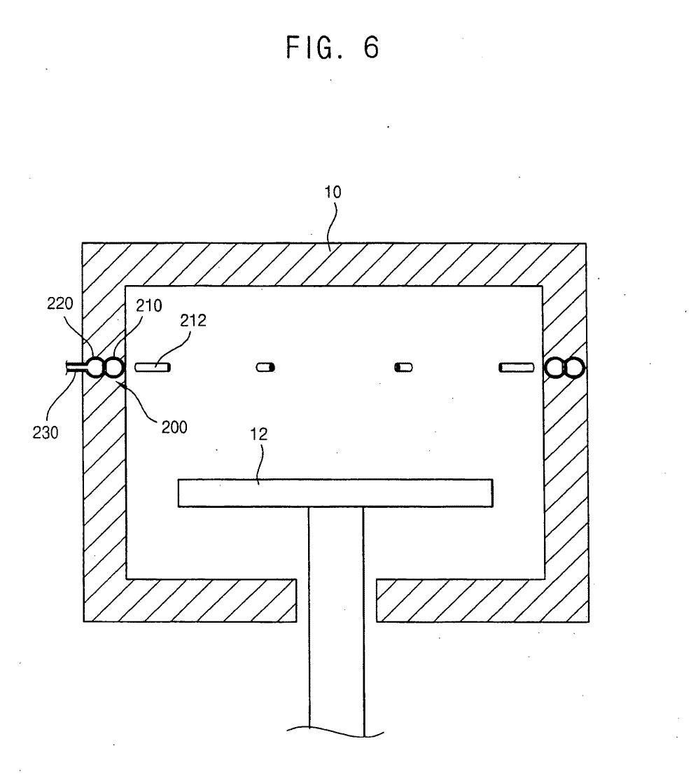

FIG. 5 is a cross-sectional view of a gas supply device in accordance with an example embodiment. FIG. 6 is a cross-sectional view of the gas supply device of FIG. 5, taken along a line VI-VI′.

Referring to FIGS. 5 and 6, the gas supply device 200 may include a first gas supply member 210 and a second gas supply member 220. The second gas supply member 220 may contact the first gas supply member 210. The first gas supply member 210 may have constructions substantially the same as the construction of the first gas supply member 110 described with reference to FIGS. 2 and 3. The second gas supply member 220 may have a circular or substantially circular shape, for example, a ring. By way of example only, the first gas supply member may have an alternative shape, for example, square, rectangular, elliptical, arcuate, polygonal, etc.

In an example, non-limiting embodiment, the second gas supply member 220 may have a cross-sectional shape that is circular or substantially circular, but is not limited thereto. By way of example only, the first gas supply member 110 may have a cross-sectional shape that is circular with a flattened edge, rectangular with rounded corners, elliptical, arcuate, polygonal, etc.

In an example, non-limiting embodiment, the second gas supply member 220 may have a diameter substantially larger than the diameter of the first gas supply member 210. For example, the first gas supply member 210 may be disposed within the cavity of the second gas supply member 220 and may contact with an inside wall of the second gas supply member 220.

In an example, non-limiting embodiment, the second gas supply member 220 may have a diameter substantially smaller that the diameter of the first gas supply member 210. For example, the second gas supply member 220 may be disposed within the first gas supply member 210 and may make contact with a wall of the second gas supply member 220.

In an example, non-limiting embodiment, the second gas supply member 220 may have a diameter which may be the same as or substantially the same as that of first gas supply member 210. For example, the second gas supply member 220 may be disposed on the first gas supply member 210 and an outside wall of the second gas supply member 220 may make contact with an outside wall of the first gas supply member 210. By way of example only, the second gas supply member may be beneath, above, or to the either side of first gas supply member 210.

A plurality of openings 222 may be formed between the first gas supply member 210 and the second gas supply member 220. For example, the openings 222 may connect the inner cavity of the first gas supply member 210 to the inner cavity of the second gas supply member 220. The openings 222 may be spaced apart by a predetermined or given distance.

If the first gas supply member 210 is disposed within the second gas supply member 220, the openings 222 may be formed along a wall of the first gas supply member 210. If the second gas supply member 220 is disposed within the first gas supply member 210, the openings 222 may be formed along a wall of the second gas supply member 220. If the first gas supply member 210 is disposed on the second gas supply member, the openings 222 may be formed in a connecting portion where the first gas supply member 210 and second gas supply member 220 may make contact.

In an example, non-limiting embodiment, the openings 222 and the nozzles 212 may be alternately disposed. For example, the openings 222 may not directly communicate with the nozzles 212. In this way, a gas supplied to the first gas supply member 210 through the openings 222 may not be directly provided to the nozzles 212. The first gas supply member 210 may be disposed substantially parallel to the second gas supply member 220. For example, the first gas supply member 210 and the second gas supply member 220 may be positioned on the same plane.

The gas supply device 200 may further include a gas reservoir (not shown) and a gas supply line 230. The gas supply line 230 may pass through the first gas supply member 210 and may be connected to the second gas supply member 220. A sealing member (not shown) may be formed where the gas supply line 230 and the second gas supply member 220 may connect. For example, the sealing member may prevent the leakage of the gas from at the connection between the gas supply line 130 and the second gas supply member 220.

The openings 222 and the portion where the second gas supply member 220 and the gas supply line 230 connect may be alternately disposed. For example, the gas supply line 230 may be connected to a portion of the second gas supply member 220 between the openings 222. In this way, the gas in the second gas supply member 220 that may be supplied through the gas supply line 230 may not be directly provided to the first gas supply member 210 through the openings 222. The gas may be more uniformly distributed in the second supply member 220 when provided to the first gas supply member 220 through the openings 222.

In an example, non-limiting embodiment, a gas supply line 230 may be connected to the second gas supply member 220. In an example, non-limiting embodiment, a plurality of gas supply lines 230 may be coupled to the second gas supply member 220. The plurality of gas supply lines 230 may be connected to one gas reservoir or a plurality of gas reservoirs (not shown), respectively.

If the gas supply device 200 includes a plurality of gas supply lines, the number of the openings 222 may be greater than the number of the gas supply lines. In this way, the gas supplied from the gas supply lines may be more uniformly provided to the first gas supply member 210 through the openings 222. If the number of the openings 230 is substantially the same as that of the gas supply lines, the uniformity of the gas supplied from the gas supply lines may be somewhat reduced in comparison with the uniformity of the gas supplied from a gas supply device 200 that may have a greater number of openings 222 than gas supply lines.

The gas supply device 200 may provide the gas, for example, a process gas or a reaction gas. onto the substrate through the nozzles 212. If the gas is more uniformly distributed through the second gas supply member 220 and the first gas supply member 210, the gas may be more uniformly provided onto the substrate, and the substrate may be more uniformly processed by the gas.

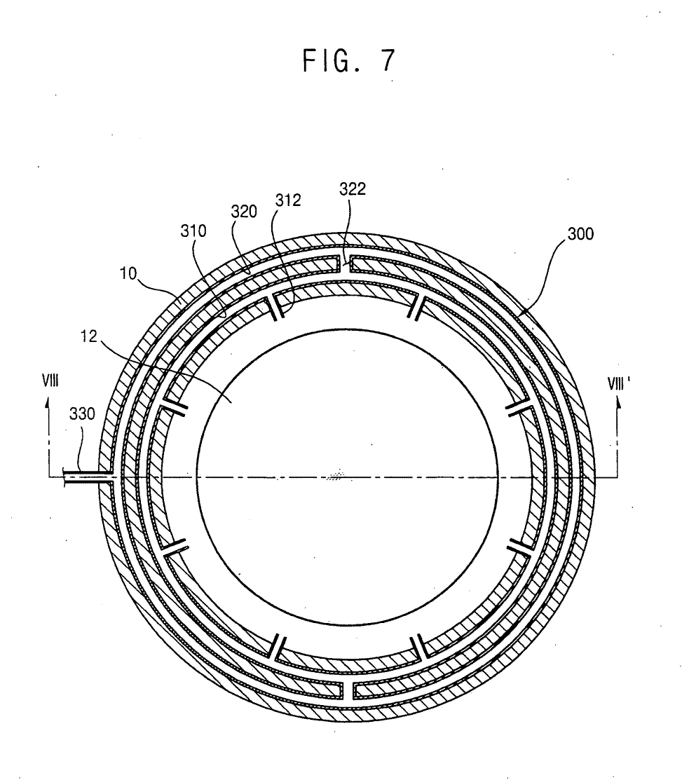

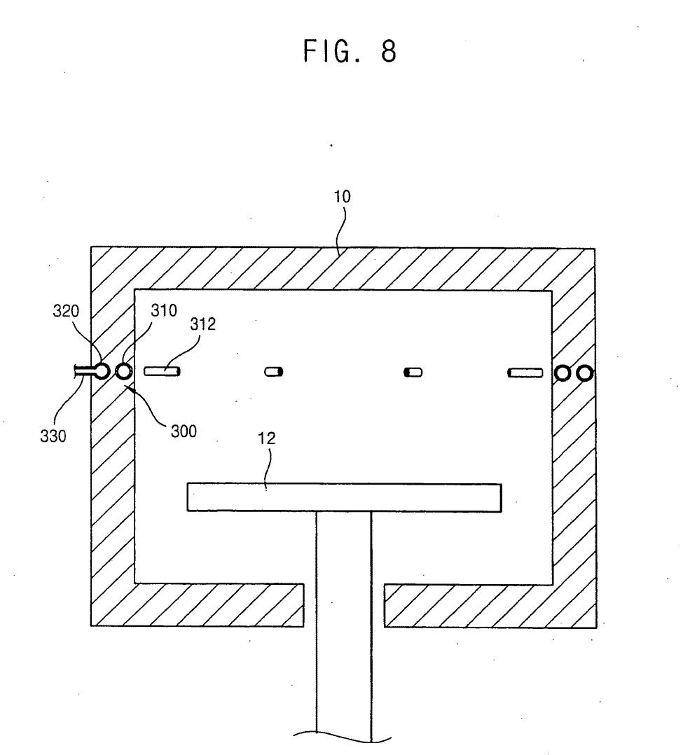

FIG. 7 is a cross-sectional view of a gas supply device in accordance with an example, non-limiting embodiment. FIG. 8 is an example cross-sectional view of the gas supply device of FIG. 7, taken along a line VIII-VIII′.

Referring to FIGS. 7 and 8, a gas supply device 300 may include a first gas supply member 310 and a second gas supply member 320. The gas supply device 300 may have a construction substantially the same as that of the gas supply device 200 described with reference to FIGS. 5 and 6, except that the first gas supply member 310 may be spaced apart from the second gas supply member 320 and an inner cavity of the first gas supply member 310 may be connected to an inner cavity of the second gas supply member 320 through a plurality of connection lines 322, instead of through the openings 222 as described with reference to FIGS. 5 and 6.

The gas supply device 300 may provide a gas, for example, a processing gas or a reaction gas, to the second gas supply member 320. The gas may be distributed to the first gas supply member 210 through the connection lines 322. The gas supply device 300 may provide the gas onto a substrate through nozzles 312. The gas may be more uniformly distributed in the first gas supply member, and accordingly the gas supply device 300 may more uniformly provide the gas onto a substrate and the substrate may be more uniformly processed by the gas.

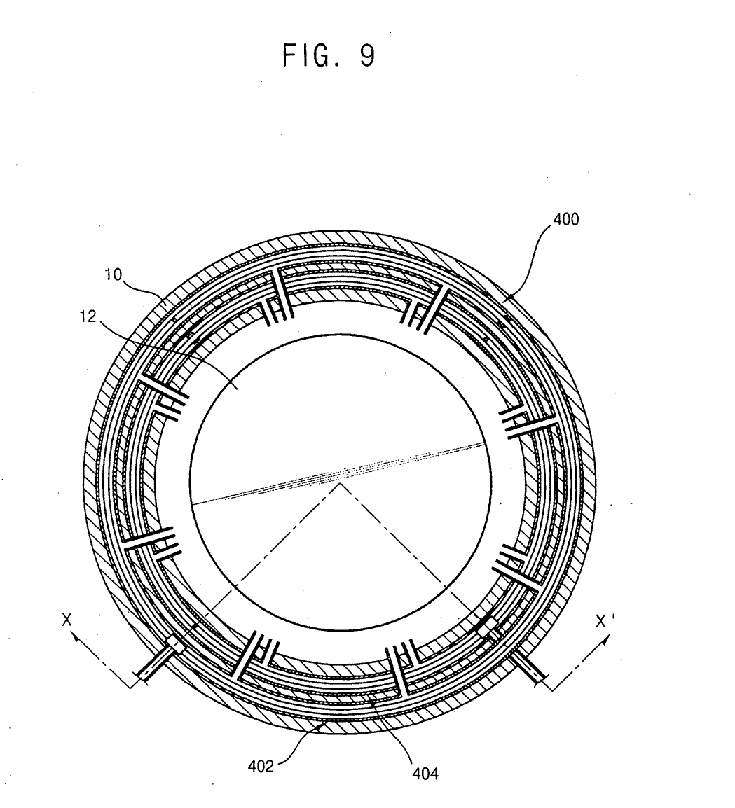

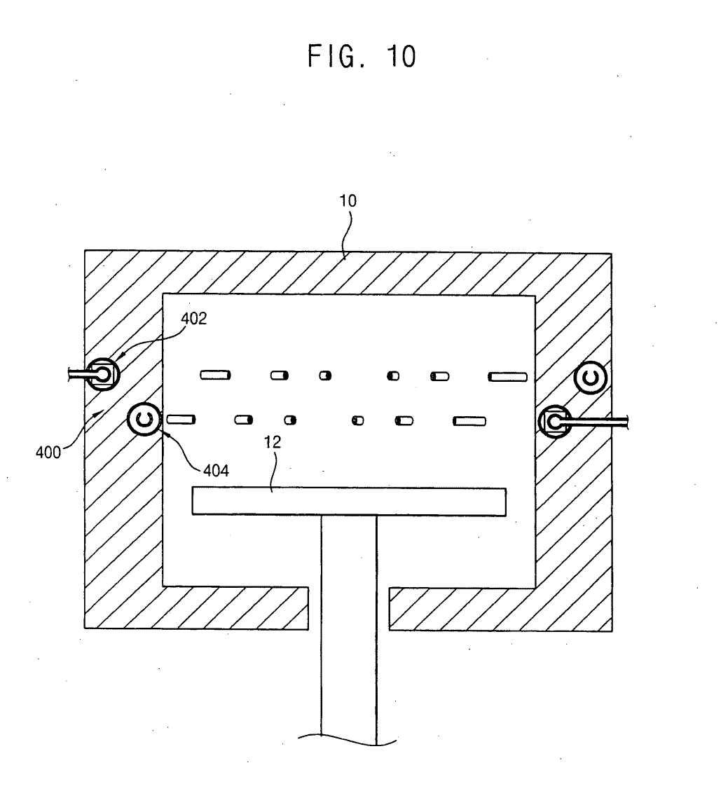

FIG. 9 is a cross-sectional view of a gas supply device in accordance with an example, non-limiting embodiment. FIG. 10 is an example cross-sectional view of the gas supply device of FIG. 9, taken along a line X-X′.

Referring to FIGS. 9 and 10, a gas supply apparatus 400 may include a first gas supply member 402 and a second gas supply member 404.

In an example, non-limiting embodiment, the first and the second gas supply members 402 and 404 may have constructions substantially the same as those of the first and the second gas supply members 110 and 120 described with reference to FIGS. 2 and 3.

In an example, non-limiting embodiment, the first and the second gas supply members 402 and 404 may have constructions substantially the same as the first and the second gas supply members 210 and 220 described with reference to FIGS. 5 and 6 or constructions substantially the same as the first and the second gas supply members 310 and 320 described with reference to FIGS. 7 and 8.

The first gas supply member 402 and the second gas supply member 404 may be sequentially disposed in a sidewall of the chamber 10. The first and the second gas supply member 402 and 404 may be connected to different gas reservoirs, respectively. For example, a first gas may be provided into a processing space of the chamber 10 through the first gas supply member 402, and a second gas different from the first gas may be provided into the processing space through the second gas supply member 404. Alternately, for example, the first and the second gas supply members 402 and 404 may be coupled to one gas reservoir or may be coupled to two different gas reservoirs both containing the first gas.

A gas, for example, a process gas or a reaction gas, may be distributed through the first and the second gas supply members 402 and 404, the gas supply device 400 may provide the gas onto a substrate supported by a stage 12. The gas may be more uniformly distributed through the first and second gas supply members, and accordingly the gas may be more uniformly provided onto the substrate and the uniformity of the substrate processed by the gas may be improved.

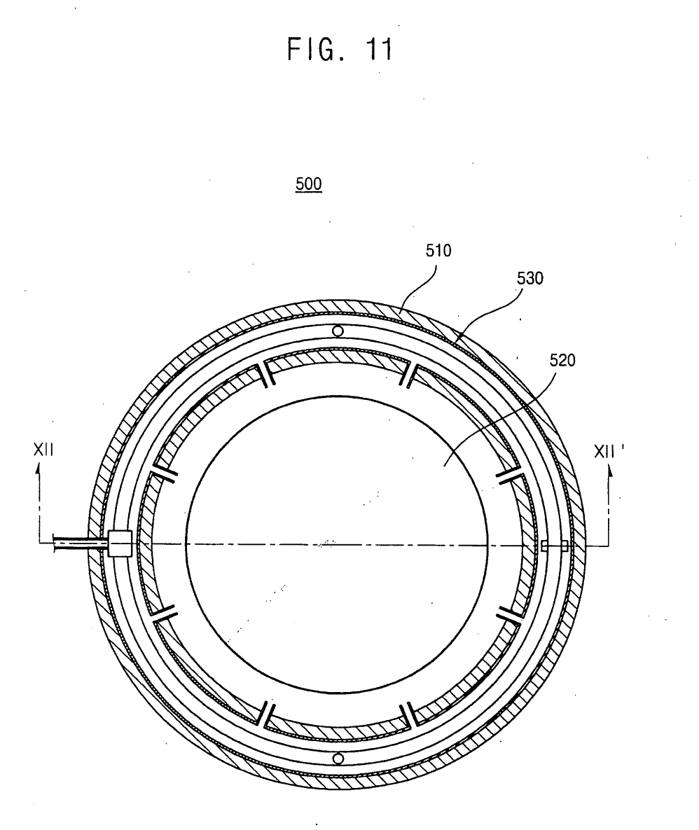

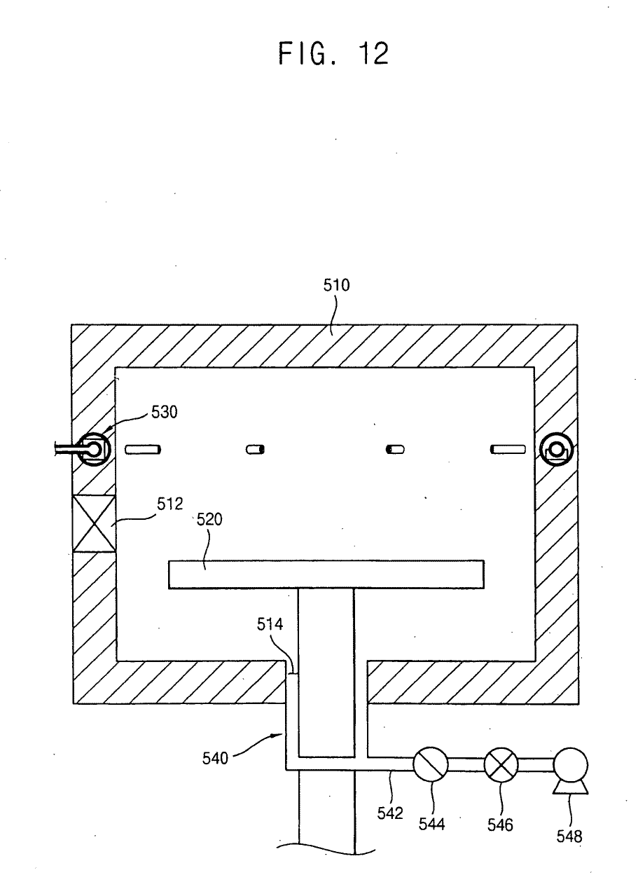

FIG. 11 is a cross-sectional view of a substrate processing apparatus in accordance with an example, non-limiting embodiment. FIG. 12 is an example cross-sectional view of the substrate processing apparatus of FIG. 11, taken along a line XII-XII.

Referring to FIGS. 11 and 12, a substrate processing apparatus 500 may include a chamber 510, a stage 520, a gas supply device 530 and a gas exhausting unit 540.

The chamber 510 may provide a processing space for a substrate. For example, the chamber 510 may have a hollow cylindrical shape. An entrance 512 may be provided at one side of the chamber 510 for loading and unloading of the substrate. An outlet 514 may be formed through a bottom of the chamber 510 to exhaust unreacted gas and reaction by-products from the chamber 510. The stage 520 may be disposed in the chamber 510. The stage 520 may horizontally support the substrate loaded in the chamber 510 for processing of the substrate.

The gas supply device 530 may provide a gas, for example, a processing gas or a reaction gas, onto the substrate. The gas supply device 530 may have a construction substantially the same as the construction of the gas supply device 100 described with reference to FIGS. 2 and 3. Alternatively, the gas supply device 530 may have a construction substantially the same as the construction of the gas supply device 200 described with reference to FIGS. 5 and 6 or the gas supply device 300 described with reference to FIGS. 7 and 8.

In an example, non-limiting embodiment, the substrate processing apparatus 500 may include one gas supply device 530 or a plurality of gas supply devices 530 that may be stacked around the substrate supported by the stage 520. Different gases may be provided from the gas supply devices onto the substrate.

The gas exhausting unit 540 may be coupled to the chamber 510. The gas exhausting unit 540 may exhaust reaction by-products and unreacted gas from the chamber 510. The gas exhausting unit 540 may include a vacuum pump 548, a vacuum line 542, a throttle valve 544 and a gate valve 546.

The vacuum pump 548 may maintain an inside of the chamber 510 in a vacuum state and may exhaust the reaction by-products and the unreacted gas generated in the processing of the substrate from the chamber 510. For example, the processing of the substrate may include a deposition processing of forming a layer on the substrate or an etching processing of the layer formed the substrate.

The vacuum line 542 may connect the outlet 514 of the chamber 510 to the vacuum pump 548. The throttle valve 544 may be disposed in the vacuum line 542 and may adjust an internal pressure of the chamber 510. The gate valve 546 may be opened and closed by the vacuum pump 548.

The substrate processing apparatus 500 may provide the gas through the gas supply device 530 onto the substrate supported by the stage 520. The gas supply device 530 may more uniformly provide the gas to the substrate, and accordingly the substrate may be more uniformly processed by the gas.

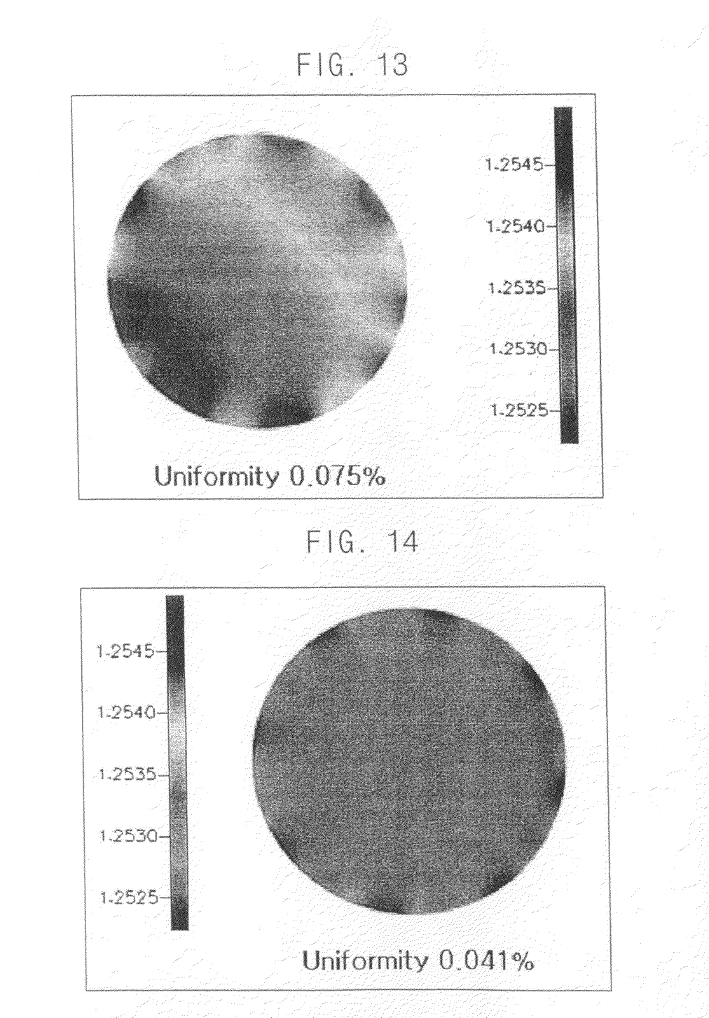

FIG. 13 is a plan view of a substrate processed using conventional gas supply devices FIG. 14 is a plan view of a substrate processed using a gas supply device in accordance with an example, non-limiting embodiment. In FIG. 13, the substrate was treated using a first gas and a second gas provided from two conventional gas supply devices. In FIG. 14, the substrate was processed using a first gas and a second gas supplied from the gas supply device described with reference to FIGS. 9 and 10. For example, the first gas and the second gas were an oxygen (O₂) gas and a silane (SiH₄) gas, respectively. A flow rate of the first gas was about 100 sccm and a flow rate of the second gas was about 80 sccm. The substrates having diameters of about 200 mm were processed in chambers having an internal pressure of about 5.0 mTorr. In FIGS. 13 and 14, vertical axes indicate concentration ratios between the first and the second gases on the substrates, respectively.

Referring to FIG. 13, a difference of the concentration ratios between the first and the second gases was higher relative to portions of the substrate. For example, a portion of the substrate adjacent to gas supply lines of the conventional gas supply devices had concentration ratios between the first and the second gases considerably higher than concentration rations at other portions of the substrate spaced further apart from the gas supply lines. The uniformity of the concentration ratios between the first and the second gases on the substrate was about 0.075 percent. If the difference of the concentration ratios between the first and the second gas (e.g., the oxygen gas and the silane gas) may be higher, the substrate may not be uniformly processed by the first and the second gases and a semiconductor device that may be formed on the substrate may have a poor reliability.

Referring to FIG. 14, a difference of the concentration ratios between the first and the second gases was substantially lower with respect to portions of the substrate. The uniformity of the concentration ratios between the first and the second gases on the substrate processed by a gas supply device according to an example embodiment was about 0.041, which was greatly improved compared to the uniformity of the concentration ratios on the substrate processed by the conventional gas supply device, which was about 0.075 percent. The flow rates of the first and the second gases provided from nozzles of the gas supply device were more uniform on the substrate irrespective of positions of gas supply lines connected gas supply members in the gas supply device. For example, when the first and the second gases corresponded to the oxygen and the silane gases, the concentration ratios between the first and the second gases met a desired value of about 1.25 (e.g., about 100 sccm/80 sccm). In this way, the first and the second gases may be more desirably mixed on the substrate irrespective of portions of the substrate. Accordingly, the substrate may be more uniformly processed by the first and the second gases supplied form the gas supply device, and a semiconductor device may have an enhanced reliability, even though the substrate may have a large diameter and the semiconductor device may have minute dimensions.

Example, non-limiting embodiments may provide a gas supply device and/or a gas supply unit that may include a first gas supply member and a second gas supply member. The second gas supply member may be connected to the first gas supply member. The first gas supply member may include nozzles for spraying a gas onto a substrate horizontally disposed in a chamber. The second gas supply member may provide the gas supplied through supply lines to the first gas supply member. The gas may be more uniformly distributed in the second gas supply member and also more uniformly distributed in the first gas supply member. Accordingly, more uniform gas may be provided onto a substrate from the gas supply device and/or the gas supply unit, and the substrate may be more uniformly processed by the gas. As a result, a semiconductor device that may be formed on the substrate may have an enhanced reliability although the substrate may have a larger diameter and the semiconductor device may have minute dimensions.

The foregoing is illustrative of example, non-limiting embodiments and is not to be construed as limiting thereof. Although a few example embodiments have been described, those skilled in the art will readily appreciate that many modifications are possible in the example embodiments without materially departing from the novel teachings and advantages. Accordingly, all such modifications are intended to be included within the scope of the present invention as defined in the claims.

What is claimed is:

1. A substrate processing apparatus comprising:
a chamber for receiving a substrate;
a stage disposed in the chamber to support the substrate;
at least one gas supply device, the at least one gas supply device including,
a first gas supply member disposed in the chamber and around the substrate loaded in the chamber, the first gas supply member including nozzles for providing a gas onto the substrate; and
a second gas supply member connected to the first gas supply member, the second gas supply member providing the gas supplied from at least one gas supply line to the first gas supply member; and
a gas exhausting unit connected to the chamber to exhaust an unreacted gas and reaction by-products from the chamber,
wherein the second gas supply member is disposed within the first gas supply member, and wherein the second gas supply member having a plurality of openings to connect an inner cavity of the second gas supply member to an inner cavity of the first gas supply member,
wherein the substrate processing apparatus comprises a plurality of gas supply units stacked around the substrate.

2. The substrate processing apparatus of claim 1, wherein the gas supply units each provide different gases onto the substrate.

3. A gas supply device comprising:
a first gas supply member disposed in a chamber and around a substrate loaded in the chamber, the first gas supply member including nozzles for providing a gas onto the substrate; and
a second gas supply member connected to the first gas supply member, the second gas supply member providing the gas supplied from at least one gas supply line to the first gas supply member,
wherein the first gas supply member is disposed within and makes contact with the second gas supply member, the second gas supply member having a plurality of openings formed between the first gas supply member and the second gas supply member to connect an inner cavity of the second gas supply member to an inner cavity of the first gas supply member.

4. The gas supply device of claim 3, wherein the plurality of openings and the at least one gas supply line are alternately disposed, and the plurality of openings and the plurality of the nozzles are alternately disposed.

5. The gas supply device of claim 3, wherein a number of the openings is greater than a number of the gas supply lines.

6. A gas supply device comprising:
a first gas supply member disposed in a chamber and around a substrate loaded in the chamber, the first gas supply member including nozzles for providing a gas onto the substrate; and
a second gas supply member connected to the first gas supply member, the second gas supply member providing the gas supplied from at least one gas supply line to the first gas supply member,
wherein the first gas supply member is disposed on the second gas supply member, and wherein a plurality of openings may be formed in the contact portion where the first gas supply member and the second gas supply member make contact, and to connect an inner cavity of the second gas supply member to an inner cavity of the first gas supply member.

7. The gas supply device of claim 6, wherein the plurality of openings and the gas supply lines are alternately disposed, and the plurality of openings and the plurality of the nozzles are alternately disposed.

8. The gas supply device of claim 6, wherein a number of the openings is greater than a number of the gas supply lines.

9. A gas supply device comprising:
a first gas supply member disposed in a chamber and around a substrate loaded in the chamber, the first gas supply member including nozzles for providing a gas onto the substrate; and
a second gas supply member connected to the first gas supply member, the second gas supply member providing the gas supplied from at least one gas supply line to the first gas supply member,
wherein the first gas supply member is spaced apart from the second gas supply member, and wherein the gas supply device includes a plurality of connection lines for connecting an inner cavity of the second gas supply member to an inner cavity of the first gas supply member.

10. The gas supply device of claim 9, wherein the connection lines and the gas supply lines are alternately disposed, and the connection lines and the plurality of the nozzles are alternately disposed.

11. The gas supply device of claim 9, wherein a number of the connection lines is greater than a number of the gas supply lines.

12. A gas supply device comprising:
a first gas supply member disposed in a chamber and around a substrate loaded in the chamber, the first gas supply member including nozzles for providing a gas onto the substrate; and
a second gas supply member connected to the first gas supply member, the second gas supply member providing the gas supplied from at least one gas supply line to the first gas supply member,
wherein the first gas supply member and the second gas supply member are each connected to a different gas reservoir.
